(19) United States
(12) Patent Application Publication
(10) Pub. No.: US 2007/0250303 A1
(43) Pub. Date: Oct. 25, 2007

(54) DESIGN SUPPORT APPARATUS

(75) Inventors: Hiroshi Imai, Hatogaya-shi (JP); Seiichi Nishio, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/736,074

(22) Filed: Apr. 17, 2007

(30) Foreign Application Priority Data
Apr. 19, 2006 (JP) P2006-115928

(51) Int. Cl. G06F 9/45

(52) U.S. Cl. 703/22

(57) ABSTRACT

A design support apparatus is for designing a logic circuit. The apparatus includes: a display device; an behavioral description storage section that stores behavioral description that describes functions of the logic circuit; a loop statement detection section that detects a loop statement that describes a repeat operation from the behavioral description; a loop statement analysis section that generates structure information that describes a structure of the loop statement by analyzing the loop statement detected by the loop statement detection section; and a display control section that controls the display device to display the structure information. The display control section controls the display device to display operations in a loop body defined by the loop statement in a time series manner.

### RELATED APPLICATION(S)

The present disclosure relates to the subject matter contained in Japanese Patent Application No. 2006-115928 filed on Apr. 19, 2006, which is incorporated herein by reference in its entirety.

### FIELD

The present invention relates to a technique for designing a semiconductor integrated circuit, and particularly to a design support apparatus used in designing a logic circuit.

### BACKGROUND

The size of system implemented on one chip is increased as growth of semiconductor technology. As one of the techniques for designing a huge system in a short time, high-level synthesis in which behavioral description describing only functions of a system (logic circuit) written in a high-level language such as a C language is synthesized to a circuit description (RTL description) including information about hardware such as a calculator, a register and a clock cycle has been known. The high-level synthesis mainly includes scheduling which assigns the operations to some clock cycle, and binding which allocates operations to the some circuit.

Behavioral description usually has a loop statement for a repeat operation. In the behavioral description written in, for example, a C language, a “for” statement, a “while” statement and a “do-while” statement are used as the loop statement. There are mainly two high-level synthesis methods applicable to the loop statement. One of the methods is a method for performing scheduling and binding without changing a repeat operation of a loop statement. The other is a method for performing scheduling and binding so as to start the second iteration before the first iteration ends in a loop statement. The latter is called pipeline synthesis. A circuit with higher throughput can be synthesized by pipeline synthesis than a normal high-level synthesis. An example of such technique is described in the following related-art document.

Cheng-Tsung Hwang et al., “Scheduling for Functional Pipelining and Loop Winding”, 28th ACM/IEEE Design Automation Conference

In the pipeline synthesis of loop statements, it is necessary to specify which loop statement is synthesized by the pipeline synthesis. Further, it is necessary to specify “delay” indicating how many cycles one iteration of the loop statement is executed and “latency” indicating how many cycle intervals each iteration starts as a high-level synthesis constraints. A desired pipeline circuit cannot be synthesized unless these values are set properly.

It is difficult to specify proper high-level synthesis constraints for synthesizing a desired pipeline circuit in the conventional methods without understanding a structure of a loop statement nor concrete information about the loop statement. Therefore, the desired pipeline circuit could not be synthesized easily in a short time.

### SUMMARY

According to a first aspect of the invention, there is provided a design support apparatus for designing a logic circuit. The apparatus includes: a display device; an behavioral description storage section that stores behavioral description that describes an function of the logic circuit; a loop statement detection section that detects a loop statement that describes a repeat operation from the behavioral description; a loop statement analysis section that generates structure information that describes a structure of the loop statement by analyzing the loop statement detected by the loop statement detection section; and a display control section that controls the display device to display the structure information. The display control section controls the display device to display operations in a loop body defined by the loop statement sequentially.

According to a second aspect of the invention, there is provided a method for designing a logic circuit. The method includes: storing behavioral description that describes an function of the logic circuit; detecting a loop statement that describes a repeat operation from the behavioral description; generating structure information that describes a structure of the loop statement by analyzing the loop statement detected by the loop statement detection section; displaying the structure information; and displaying operations in a loop body defined by the loop statement sequentially.

According to a third aspect of the invention, there is provided a design support apparatus for designing a logic circuit. The apparatus includes: a display device; a storage that stores behavioral description that describes a function of the logic circuit; and a processor. The processor operates to: detect a loop statement that describes a repeat operation from the behavioral description; generate structure information that describes a structure of the loop statement by analyzing the loop statement detected by the loop statement detection section; control the display device to display the structure information; and control the display device to display operations in a loop body defined by the loop statement sequentially.

### BRIEF DESCRIPTION OF THE DRAWINGS

In the accompanying drawings:

FIG. 1 is a functional block diagram showing the whole configuration example of a design support apparatus according to an embodiment of the invention;

FIG. 2 is a pseudo-code showing one example of behavioral description used in the design support apparatus according to the embodiment;

FIG. 3 is a diagram showing a display example in the case of using the behavioral description of FIG. 2;

FIG. 4 is a flowchart showing a process flow example of loop statement display process according to the embodiment;

FIG. 5 is a functional block diagram showing a configuration example of a loop statement analysis section according to the embodiment;

FIG. 6 is a diagram showing a display example in the case where each operation in a loop statement in the behavioral description of FIG. 3 is parallel executable;

FIG. 7 is a diagram showing a display example in the case of instructing a loop statement in the behavioral description of FIG. 3 to unroll;

FIG. 8 is a pseude-code showing a behavioral description example including a loop statement having a hierarchical structure;

FIG. 9 is a diagram showing a display example of the behavioral description of FIG. 8;

FIG. 10 is a flowchart showing a detection process flow of a hierarchical structure of a loop statement;

FIG. 11 is a diagram showing a display example in the case of specifying a pipeline operation;

FIG. 12 is a diagram showing a display example in the case of specifying a pipeline operation to a loop statement having a hierarchical structure;

FIG. 13 is a diagram showing a display example in the case of specifying a pipeline operation to a loop statement having a data dependency;

FIG. 14 is a diagram showing a display example in the case of specifying a pipeline operation to a loop statement having a data dependency beyond hierarchy;

FIG. 15 is a diagram showing a display example in the case of prompting a designer to input pipeline synthesis constraints;

FIG. 16 is a diagram showing a display example in the case of prompting a designer to input pipeline synthesis constraints in the case of having a hierarchical structure;

FIG. 17 is a diagram showing a display example in the case of prompting a designer to input pipeline synthesis constraints in the case where a loop statement has a data dependency;

FIG. 18 is a diagram showing an example of specifying pipeline synthesis constraints in the case where there is a data dependency beyond hierarchy;

FIG. 19 is a pseudo-code showing an example of behavioral description in which high-level synthesis constraints are embedded;

FIG. 20 is a pseudo-code showing an example of behavioral description in which high-level synthesis constraints are embedded in the case where a loop statement has a hierarchical structure;

FIG. 21 is a pseudo-code showing an example of behavioral description in which high-level synthesis constraints are embedded in the case where a loop statement has a data dependency; and

FIG. 22 is a pseudo-code showing an example of behavioral description in which high-level synthesis constraints are embedded in the case where there is a data dependency beyond hierarchy.

### DETAILED DESCRIPTION OF THE EMBODIMENT(S)

An embodiment of the present invention will be described below with reference to the drawings. In the following description of the drawings, same or similar portions are marked with same or similar symbols, respectively.

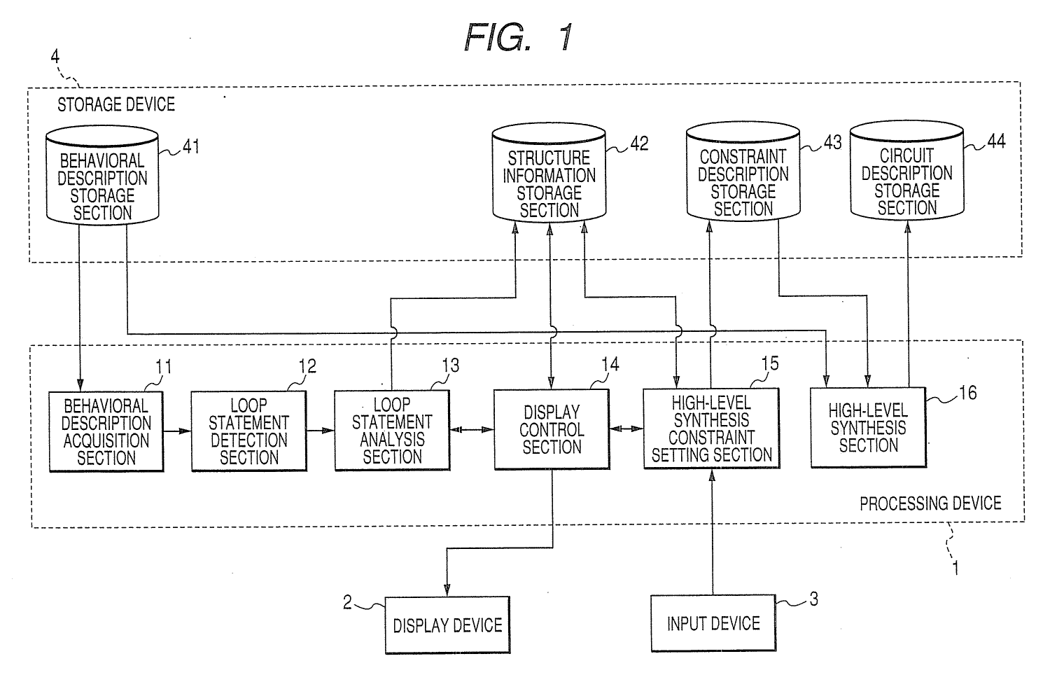

A design support apparatus according to the embodiment of the invention includes a storage device 4, a processing device 1, a display device 2 and an input device 3 as shown in FIG. 1. An auxiliary storage device, such as a hard disk or memory such as ROM and RAM, can be used as the storage device 4. A CPU can be used as the processing device 1. A liquid crystal display and a CRT display can be used as the display device 2. A keyboard and a mouse can be used as the input device 3.

The storage device 4 stores various data including behavioral description and also stores a control program executed by the processing device 1. The “behavioral description” herein means that functions of a system (logic circuit) are written in a high-level language. One example of the behavioral description in C language will be explained below. The processing device 1 implements respective functions of a behavioral description acquisition section 11, a loop statement detection section 12, a loop statement analysis section 13, a display control section 14, a high-level synthesis constraint setting section 15 and a high-level synthesis section 16 by executing the control program stored in the storage device 4.

The behavioral description acquisition section 11 acquires behavioral description previously stored in a behavioral description storage section 41 of the storage device 4. The behavioral description acquired by the behavioral description acquisition section 11 is inputted to the loop statement detection section 12. The loop statement detection section 12 detects loop statements in the behavioral description. The “loop statement” herein means that a repeat operation is described, and a “for” statement, a “while” statement, and a “do-while” statement are the loop statements the C language. Also, the loop statement detection section 12 assigns labels (identifiers) to the detected loop statements.

The loop statement analysis section 13 generates structure information indicating structures of loop statements by analyzing the loop statement detected by the loop statement detection section 12. The “structure information” means, for example, a name of a function including a loop statement, a label of a loop statement, the number of unrolls, an initialization expression (hereinafter called “loop variable initialization”) for setting initial value of a loop variable for controlling repeat process, a conditional expression (hereinafter called “a repeat determination condition”) which is a determination condition of an iteration of a loop, a resetting expression (hereinafter called “loop variable updating”) for resetting (updating) a loop variable, calculations in a loop statement or functions called in a loop statement, and execution sequence of calculations in a loop statement or calling sequence of functions called in a loop statement. The structure information generated by the loop statement analysis section 13 is stored in a structure information storage section 42 of the storage device 4.

Hereinafter, the calculations in a loop statement or the functions called in a loop statement are called “operations in a loop body”. The “number of unrolls” means how many times the iteration of the loop body is unrolled. The structure information generated by the loop statement analysis section 13 is registered in the structure information storage section 42.

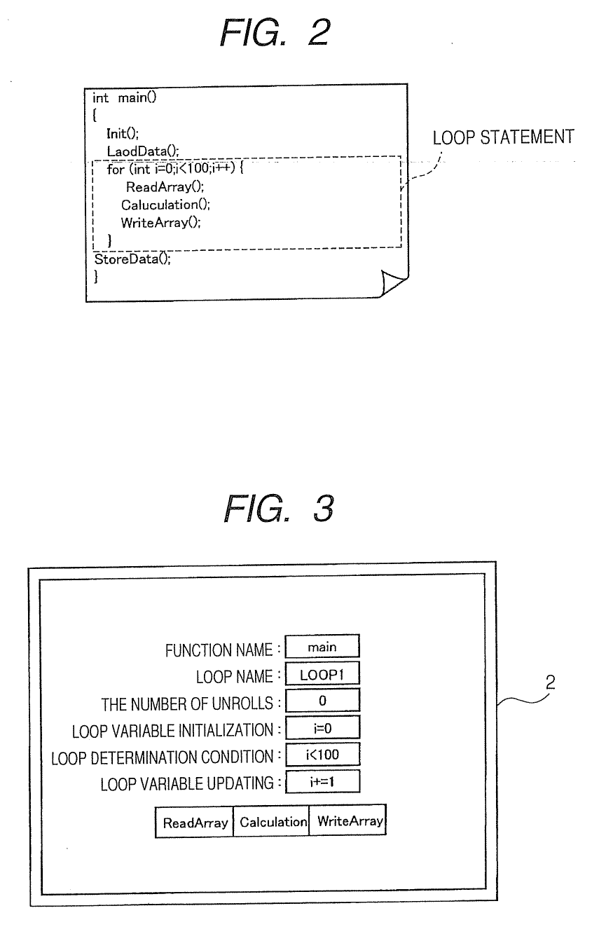

In the behavioral description example shown in FIG. 2, the function name having a loop statement is “main” and the label “LOOP1” is assigned and the number of unrolls is “0” and loop variable initialization is “i=0” and a repeat determination condition is “i<100” and loop variable updating is “i++” and operations of a loop body are three functions “ReadArray”, “Calculation” and “WriteArray”.

The display control section 14 displays structure information registered in the structure information storage section 42 on the display device 2. In that case, the display control section 14 displays operations of a loop body sequentially on the display device 2. That is, for the operations of the loop body, one iteration is displayed in a horizontal bar graph in which time flows from left to right as shown in FIG. 3. In the example of FIG. 3, the function names called in a loop statement are displayed in the rectangles in a bar graph.

By displaying detailed information about a loop statement on the display device 2, a designer can easily specify the loop statement to be synthesized by the pipeline synthesis. Further, by displaying operations of a loop body sequentially, the designer can understand the execution order of the operations of the loop body.

The high-level synthesis constraint setting section 15 sets high-level synthesis constraints and a loop statement to be synthesized by the pipeline synthesis according to an input operation which a designer performs using the input device 3. The “pipeline synthesis” herein means that scheduling and binding are performed so as to start the second iteration before the first iteration ends in the loop statement at the time of high-level synthesis. The “high-level synthesis constraints” herein mean “delay” indicating how many cycles one iteration of a loop statement is executed and “latency” indicating how many cycle intervals each iteration starts in.

The setting of the high-level synthesis constraints is stored in the structure information storage section 42. Also, the high-level synthesis constraint setting section 15 generates high-level synthesis constraint description (constraint script) which is description capable of being recognized by the high-level synthesis section 16 based on the set high-level synthesis constraints. The generated high-level synthesis constraint description is stored in a constraint description storage section 43.

The high-level synthesis section 16 performs high-level synthesis of the behavioral description stored in the behavioral description storage section 41 using the high-level synthesis constraint description stored in the constraint description storage section 43. Also, the high-level synthesis section 16 synthesizes the specified loop statement by the pipeline synthesis. As a result of this, circuit description (RTL description) including information about hardware such as a functional unit, a register and a clock cycle is generated from the behavioral description. The generated circuit description is stored in a circuit description storage section 44. Details of high-level synthesis process using the high-level synthesis constraint description will be explained below.

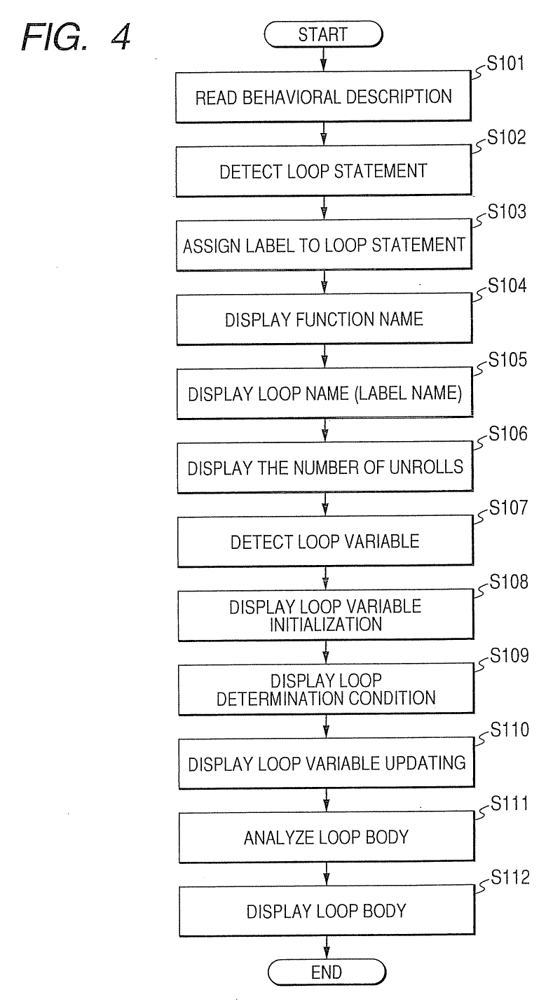

Next, an outline of display process in the design support apparatus according to the embodiment of the invention will be explained with reference to a flowchart shown in FIG. 4.

In step S101, the behavioral description acquisition section 11 reads behavioral description from the behavioral description storage section 41.

In step S102, the loop statement detection section 12 detects loop statements in the behavioral description read in step S101.

In step S103, the loop statement analysis section 13 assigns a label to the loop statement detected in step S102.

In step S104, the display control section 14 displays a name of a function including the loop statement detected in step S102 on the display device 2.

In step S105, the display control section 14 displays a label of the loop statement detected in step S102 on the display device 2.

In step S106, the display control section 14 displays the number of unrolls of the loop statement detected in step S102 on the display device 2. At this point, unroll is not executed, so that “0” is displayed as an initial value.

In step S107, the loop statement detection section 12 detects a loop variable for controlling the number of iterations of the loop statement detected in step S102.

In step S108, the display control section 14 displays loop variable initialization on the display device 2.

In step S109, the display control section 14 displays a repeat determination condition on the display device 2.

In step S110, the display control section 14 displays loop variable updating on the display device 2.

In step S111, the loop statement analysis section 13 analyzes operations in a loop body. In this analysis, for example, a technique of data flow analysis can be used. Details of loop statement analysis process will be explained below.

In step S112, the display control section 14 displays the operations of the loop body in a bar graph.

The process flow explained above can also be applied to the case of including plural loop statements in the behavioral description.

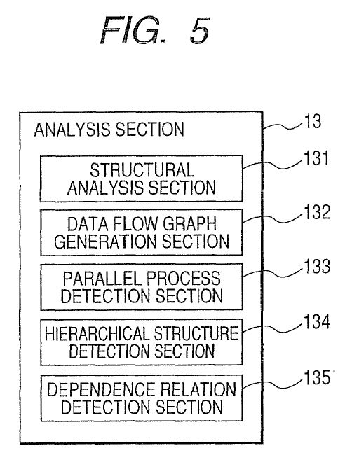

An example of configuration of the loop statement analysis section 13 is shown in FIG. 5. The loop statement analysis section 13 includes a structural analysis section 131, a data flow graph generation section 132, a parallel operation detection section 133, a hierarchical structure detection section 134 and a dependency detection section 135 as shown in FIG. 5. The structural analysis section 131 generates the structure information explained above.

The data flow graph generation section 132 generates a data flow graph from operations in a loop body. The “data flow graph” herein means a graph in which each operation is linked according to a data dependency of operands. The generated data flow graph is used in the parallel operation detection section 133, the hierarchical structure detection section 134 and the dependency detection section 135.

Next, the parallel operation detection section 133 will be explained. The parallel operation detection section 133 detects parallel executable operations in a loop body based on the data flow graph generated by the data flow graph generation section 132 in step S111 of FIG. 4. Information about the detected parallel executable operations is registered in the structure information storage section 42.

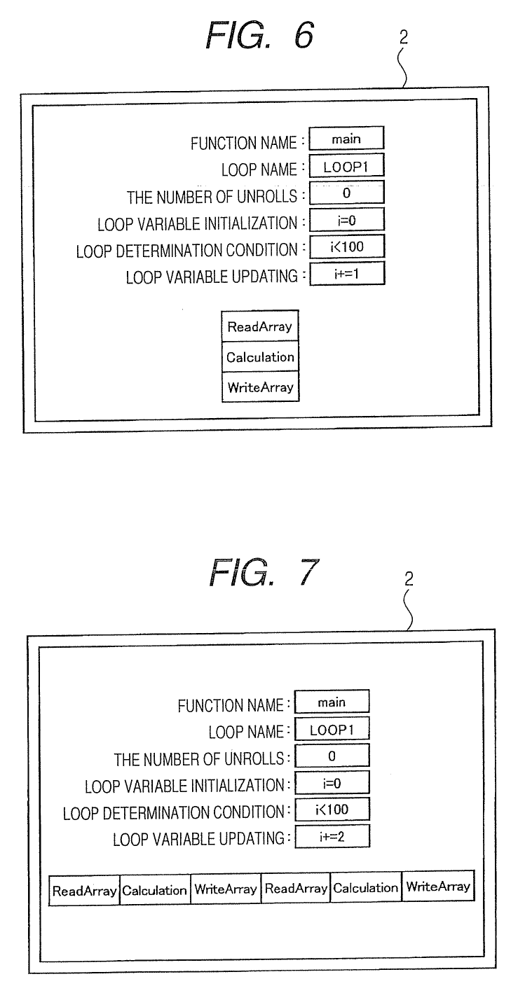

The display control section 14 displays the parallel executable operations in a direction orthogonal to a time axis direction when the loop body is arranged and displayed in the time axis direction in step S112 of FIG. 4. For example, when a function “ReadArray”, a function “Calculation” and a function “WriteArray” can be parallel executed in the behavioral description example shown in FIG. 2, respective rectangles of the function “ReadArray”, the function “Calculation” and the function “WriteArray” are stacked and displayed as shown in FIG. 6.

Next, display and structure information about a loop statement in the case of unrolling a loop statement will be explained. When a loop statement, which designer wants to synthesis to pipeline, further has a loop statement, it is necessary to unroll the loop statement of the inside of the loop statement. In such a case, unroll instructions are given. The “unroll instructions” herein mean duplication of operations in a loop body and connecting them in a sequential manner. The number of unrolls is registered in the structure information storage section 42.

The display control section 14 duplicates operations in a loop body according to the number of unrolls registered in the structure information storage section 42 and displays the duplicated operations of the loop body arranged in a time axis direction. When an unroll is instructed, an expression of loop variable updating is changed, so that the display control section 14 displays the loop variable updating according to the number of unrolls.

For example, when one unroll is instructed in the behavioral description example shown in FIG. 2, that is, when one duplication of a loop body is created, one bar graph of the loop body is duplicated and is displayed with the bar graph arranged in a time axis direction as shown in FIG. 7. Also, the loop variable updating is “i++” in FIG. 3 but is “i+=2” in FIG. 7.

Next, the hierarchical structure detection section 134 will be explained. The hierarchical structure detection section 134 detects hierarchical structure information indicating that a loop statement is included in a loop statement. The detected hierarchical structure information is registered in the structure information storage section 42. The display control section 14 regards the loop statement included in the loop statement as a lower hierarchy and displays a loop statement of an upper hierarchy and a loop statement of the lower hierarchy under it in a direction orthogonal to a time axis direction.

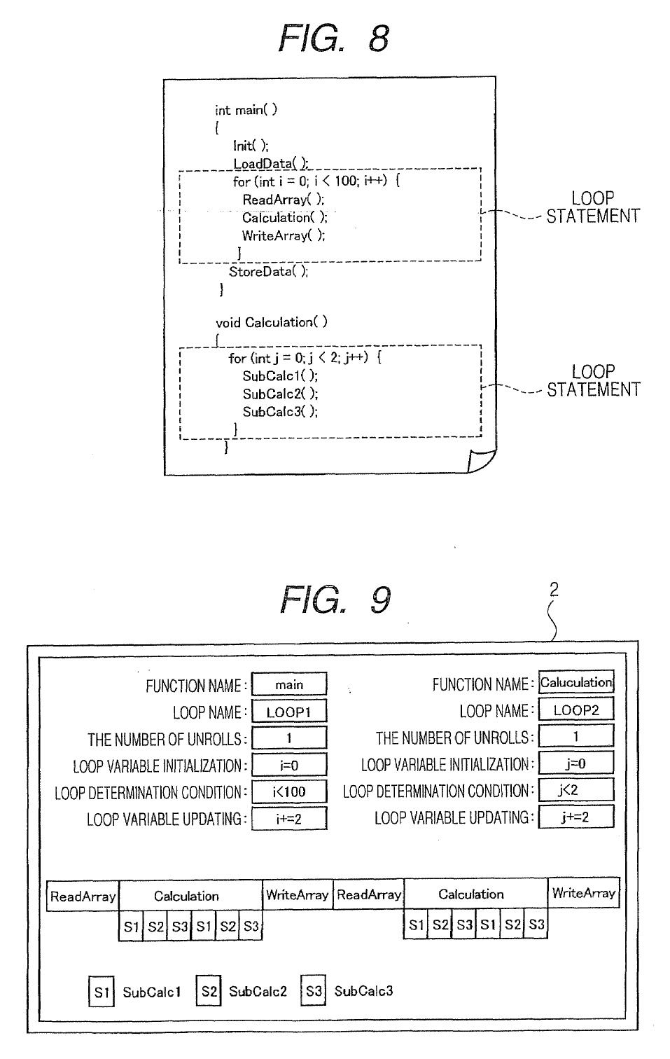

An example of behavioral description including loop statements having a hierarchical structure is shown in FIG. 8. In the example of FIG. 8, a function “Calculation” in a loop statement in a main function further has a loop statement. A loop body of the loop statement in the function “Calculation” includes functions “SubCalc1”, “SubCalc2” and “SubCalc3”.

A display example of the case where both specifications of the number of unrolls of two loop statements of FIG. 8 are 1 is shown in FIG. 9. In the example of FIG. 9, a label “LOOP1” is assigned to a loop statement in a main function and a label “LOOP2” is assigned to a loop statement in a function “Calculation”. The display control section 14 displays a state of having a hierarchical structure in a form of stacking operations in a loop body of the loop statement indicated by the “LOOP2” under a rectangle of the function “Calculation” by display of a bar graph shape.

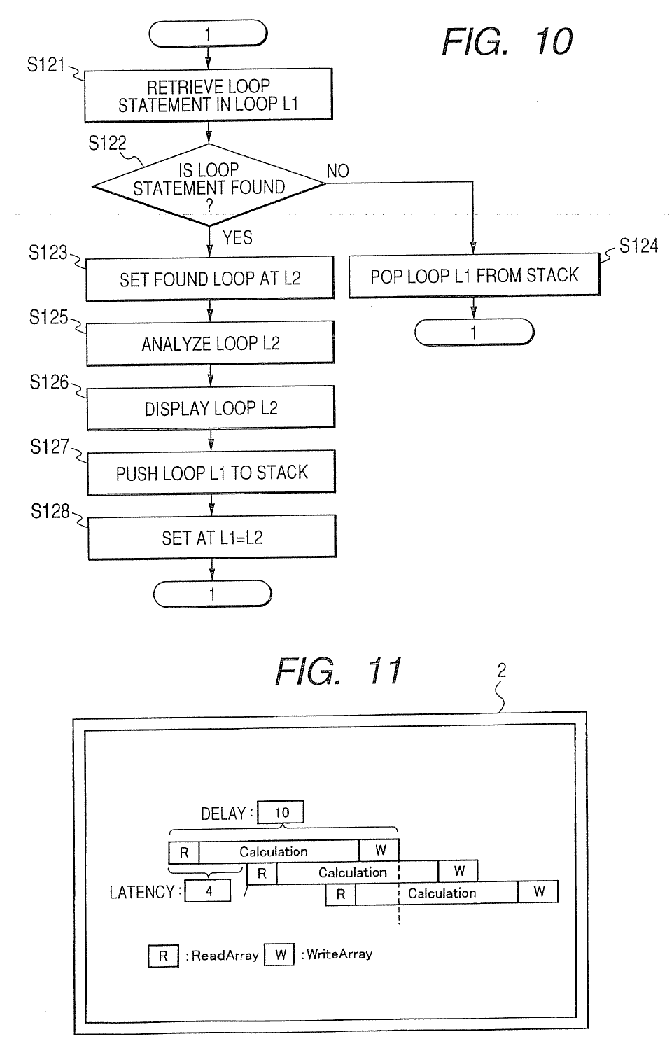

Next, a process flow of the hierarchical structure detection section 134 will be explained with reference to a flowchart shown in FIG. 10. The process flow shown in FIG. 10 is executed in step S111 of FIG. 4.

In step S121, the hierarchical structure detection section 134 retrieves a loop statement in a loop statement L1.

In step S122, the hierarchical structure detection section 134 determines whether or not the loop statement is found in the loop statement L1. In the case that the loop statement is not found in the loop statement L1, the hierarchical structure detection section 134 pops the loop statement L1 from a stack.

In the case that the loop statement is found in the loop statement L1, the found loop statement is assigned a label L2 in step S123 and the loop statement L2 is analyzed in step S125. This analysis is conducted by the structural analysis section 131 etc. As a result of this, structure information about the loop statement L2 is acquired.

In step S126, the display control section 14 displays the structure information about the loop statement L2 acquired in step S125.

In step S128, the loop statement L2 is assigned the label L1 and a hierarchical structure is analyzed recursively from step S121.

The process flow of the hierarchical structure detection section 134 can cope easily with the case where there are plural loop statements in a loop body.

Next, display and structure information about a loop statement in the case of specifying a loop statement to be synthesized to pipeline will be explained. The case of specifying a loop statement of the behavioral description shown in FIG. 2 to be synthesized to pipeline will be explained. In this case, a delay value and a latency value of the pipeline operation are added to the structure information about a loop statement.

A display example of the case of specifying that a delay value is 10 and a latency value is 4 is shown in FIG. 11. The number of clock cycles necessary for execution of one iteration of a loop statement is used as delay, and latency indicating how many cycle intervals each iteration starts in is displayed. Also, bar graph-shaped rectangles indicating operations of a loop body are shifted by the delay value and are displayed with the rectangles stacked vertically by [delay/latency], that is, [10/4]=3. Herein, calculation “[x]” indicates the minimum integer larger than or equal to x (round up).

Next, display and structure information about a loop statement in the case of specifying a pipeline for a loop statement having a hierarchical structure will be explained. The hierarchical structure of the loop statement is added to the structure information for the loop statement. The case of specifying a loop statement having a hierarchical structure of the behavioral description shown in FIG. 8 to be synthesized to pipeline will be explained.

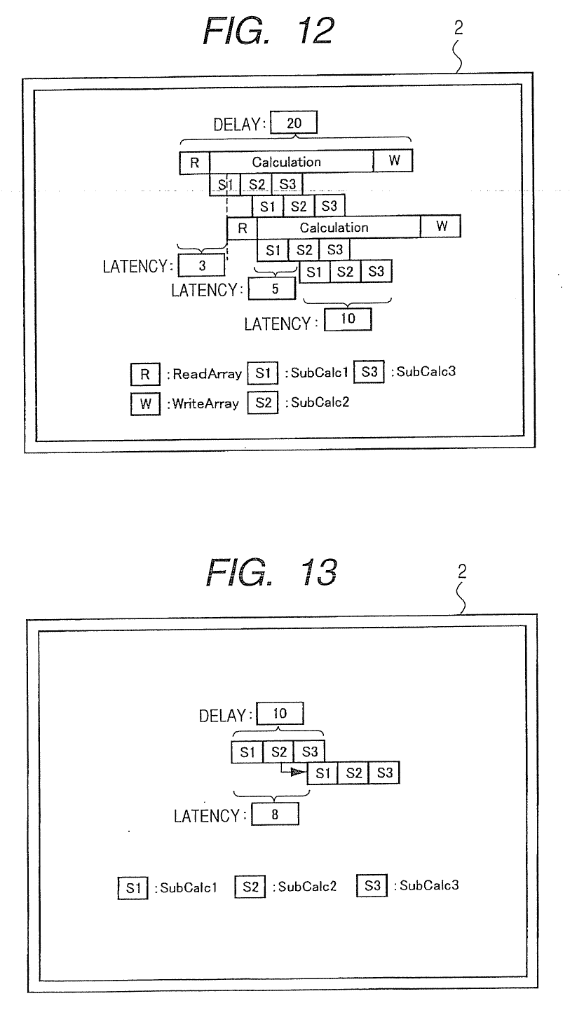

An example of specifying that delay is 20 and latency is 3 for a loop statement in a main function and delay is “10” and latency is “5” for a loop statement in a function “Calculation” is shown in FIG. 12.

The operations in the loop statement in the function “Calculation” is displayed stacked vertically by [delay/latency], that is, [10/5]=2. The operations in the loop statement in the main function is displayed shifted by [delay/latency], that is, [20/3]=7. However, in the example shown in FIG. 12, only two are written for simplicity.

Even when the loop statement has the hierarchical structure, a designer can easily specify the loop statement to be synthesized to pipeline by displaying operations in a loop body of each of the loop statements in a time series manner.

Next, the dependency detection section 135 will be explained. The dependency detection section 135 determines whether or not operations of a loop body depends on results of operations of the previous iteration by analyzing a data flow graph generated by the data flow graph generation section 132. Information about a dependency is stored in the structure information storage section 42.

The case where the function “SubCalc1” in the loop statement in the function “Calculation” of the behavioral description shown in FIG. 8 depends on a result of the previous iteration of the function “SubCalc2” will be explained as one example. Pipeline display of a loop statement in the case of specifying that delay is 10 and latency is 8 is shown in FIG. 13. A data dependency is represented by an arrow from a rectangle with a label S2 to a rectangle with a label S1.

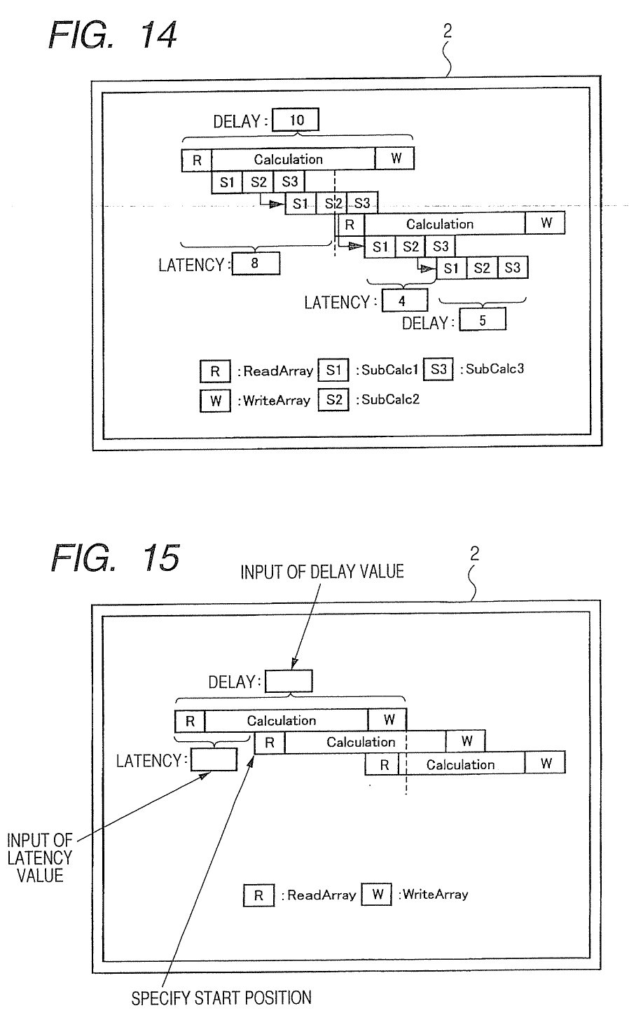

Pipeline display in the case where there is a data dependency beyond a hierarchical structure will be explained as another example. The case where the function “SubCalc1” depends on a result of execution of the function “SubCalc2” in the previous iteration of the function “Calculation” in FIG. 8 will be explained. Its Pipeline display in this case is shown in FIG. 14. In this display, a data dependency between “SubCalc2” and “SubCalc1” is represented by arrows written between rectangles with labels S2 and rectangles with labels S1 beyond an iteration of a loop statement in a main function.

Therefore, even when operations in a loop statement depend on a result of the previous iteration even in the case where the loop statement has a data dependency, a designer can easily set high-level synthesis constraints.

Details of the high-level synthesis constraint setting section 15 will be explained. A method of setting high-level synthesis constraints for a loop statement of the behavioral description shown in FIG. 2 will be explained first. An example of graphical display for high-level synthesis constraint setting of a pipeline is shown in FIG. 15.

A designer is prompted to input the number of cycles necessary for one execution of a loop body to a box labeled with “delay:”. As explained above, in a pipeline, the operation is started with a loop body shifted by a certain number of cycles. The designer specifies a start point of operations in the loop body by dragging and shifting using, for example, a mouse as the input device 3. Or, the designer inputs the number of cycles of its shift to a box labeled with “latency:” using, for example, a keyboard as the input device 3.

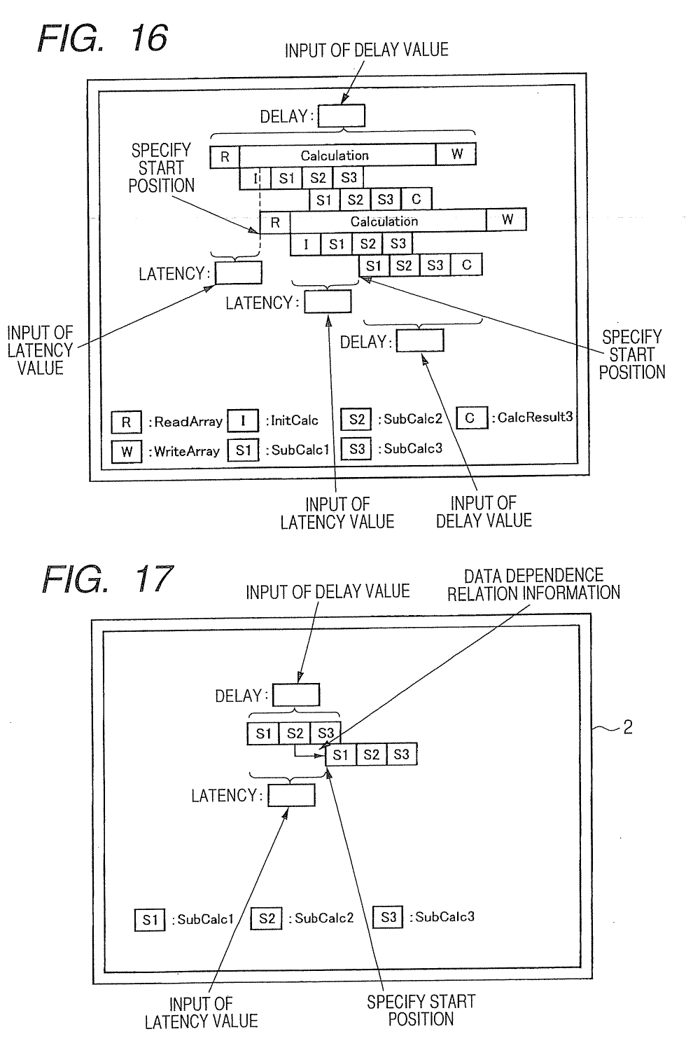

Next, a method of specifying high-level synthesis constraints in the case where a loop statement has a hierarchical structure will be explained. The case of specifying high-level synthesis constraints for a pipeline to the loop statement in the function “Calculation” and the loop statement in the main function of the behavioral description shown in FIG. 8 will be explained. An example of graphical display for high-level synthesis constraint setting for a pipeline in this case is shown in FIG. 16.

In a manner similar to the case of no hierarchy, each of the loop statements is prompted to input the number of cycles necessary for one execution of a loop body to a box labeled with “delay:”. A designer specifies a shift in a process start of the loop body by dragging and shifting a start point of operations in the loop body. Or, the designer inputs the number of cycles of its shift to a box labeled with “latency:”.

Next, the method of specifying high-level synthesis constraints for a pipeline in the case where a loop body depends on the results of the operations of the previous iteration will be explained.

The case where the function “SubCalc1” of the loop statement in the function “Calculation” of the behavioral description shown in FIG. 8 depends on a result of the previous iteration of the function “SubCalc2” will be explained as the first example. An example of graphical display for high-level synthesis constraint setting of a pipeline in this case is shown in FIG. 17. In a manner similar to the example shown in FIG. 14, it is prompted to input the number of cycles necessary for one execution of a loop body to a box labeled with “delay:”.

A designer specifies a shift in a start point of the loop body by dragging and shifting a start point of operations of the loop body. Or, the designer inputs the number of cycles of its shift to a box labeled with “latency:”. Start timing of operations can be moved to the left by dragging until a direction of an arrow representing a data dependency changes to the left because of a data dependency between the function “SubCalc2” and the function “SubCalc1”.

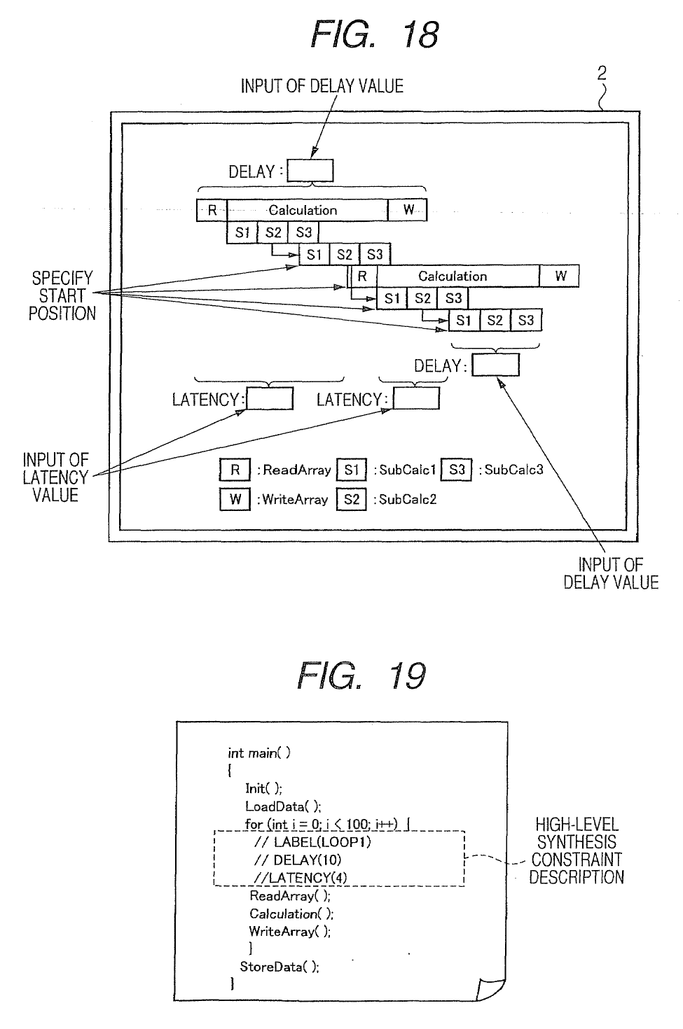

Pipeline display in the case where there is a data dependency beyond a hierarchical structure will be explained as the second example. The case where the function “SubCalc1” depends on a result of the previous iteration beyond hierarchy of a loop of the function “SubCalc2” in the example of the behavioral description shown in FIG. 8 will be explained. An example of graphical display for high-level synthesis constraint setting for a pipeline in this case is shown in FIG. 18. In a manner similar to the example shown in FIG. 13, for each loop statement, designer is prompted to input the number of cycles necessary for one execution of a loop body to a box labeled with “delay:”.

A designer specifies a shift in a start of the loop body by dragging and shifting a start point of operations of the loop body. Or, the designer inputs the number of cycles of its shift to a box labeled with “latency:”. A start point of operations can be moved to the left by dragging until a direction of an arrow representing a data dependency between functions changes to the left.

Next, generation process of high-level synthesis constraint description by the high-level synthesis constraint setting section 15 will be explained.

The case of setting high-level synthesis constraints in which delay is 10 and latency is 4 as shown in FIG. 11 for the behavioral description shown in FIG. 2 will be explained as one example. An example of behavioral description in which the high-level synthesis constraints in this case are embedded is shown in FIG. 19. In this example, a label LOOP1 is assigned to a loop statement. Delay and latency are specified by two scripts of DELAY(10) and LATENCY(4) under the label of the loop statement.

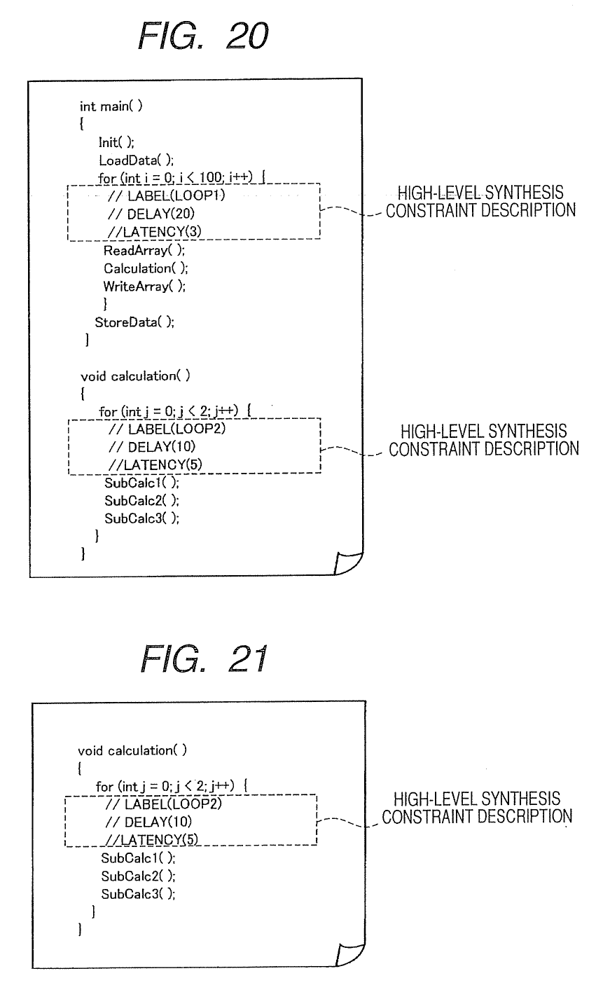

Next, process for generating high-level synthesis constraint description of a pipeline in the case where a loop statement has a hierarchical structure will be explained. The case of specifying that delay of the loop statement (to which a label LOOP1 is assigned) in the main function is 20 and latency is 3 and delay of the loop statement (to which a label LOOP2 is assigned) in the function “Calculation” is 10 and latency is 5 as shown in FIG. 12 for the behavioral description shown in FIG. 8 will be explained. An example of behavioral description in which high-level synthesis constraints in this case are embedded is shown in FIG. 20. Delay values and latency values are specified by DELAY( ) statements and LATENCY( ) statements under the label of the loop statement.

Next, high-level synthesis constraint description generation of a pipeline in the case where a loop body depends on the results of operations of the previous iteration will be explained.

The case where the function “SubCalc1” in the loop statement (to which a label LOOP2 is assigned) in the function “Calculation” of the behavioral description shown in FIG. 8 depends on a result of the previous execution of the function “SubCalc2” will be explained as one example.

It is assumed that delay is set to 10 and latency is set to 8 for LOOP2 as shown in FIG. 13. An example of behavioral description in which high-level synthesis constraints in this case are embedded is shown in FIG. 21. A delay value and a latency value are specified by a DELAY( ) statement and a LATENCY( ) statement under the label of the loop statement. A data dependency is considered by scheduling process in the high-level synthesis section 16.

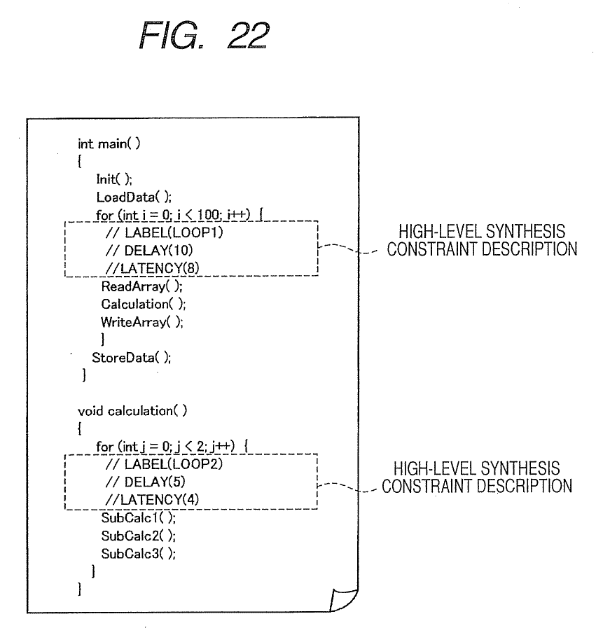

Pipeline display in the case where there is a data dependency beyond a hierarchical structure will be explained as another example. An example of behavioral description is shown in FIG. 8. The example is the case where the function “SubCalc1” depends on the result of the previous execution of the function “SubCalc2” beyond hierarchy of the loop LOOP2. It is assumed that delay is set to 10 and latency is set to 8 for the loop statement (to which a label LOOP1 is assigned) in the main function and delay is set to 5 and latency is set to 4 for LOOP2 as shown in FIG. 14. An example of behavioral description in which high-level synthesis constraints in this case are embedded is shown in FIG. 22. Delay values and latency values are specified by DELAY( ) statements and LATENCY( ) statements under the label. A data dependency is considered by scheduling process in the high-level synthesis 16.

As explained above in detail, according to the embodiment of the invention, a designer can easily decide which loop statement should be synthesized by pipeline synthesis. Therefore, time necessary for pipeline synthesis can be reduced, so that time required for the whole high-level synthesis can be reduced.

Also, a designer is prompted to input high-level synthesis constraints of pipeline synthesis and thereby proper high-level synthesis constraints for synthesizing a desired pipeline circuit can easily be specified, so that a desired circuit can easily be synthesized using high-level synthesis.

Further, high-level synthesis can be executed automatically using high-level synthesis constraint description stored in the high-level synthesis constraint storage section 43. That is, an error in constraint specification by hand is eliminated by generating the high-level synthesis constraint description from high-level synthesis constraints set based on structure information about a loop statement.

As explained above, the invention has been described by the embodiment, but it should not be understood that the discussion and drawings forming a part of this disclosure limit this invention. From this disclosure, various alternative embodiments, examples and operation techniques will become apparent to those skilled in the art.

In the embodiment explained above, one example of setting a time axis direction in a horizontal direction of the display device 2 has been explained, but the time axis direction may be set in a vertical direction of the display device 2.

Also, the case of writing behavioral description in the C language has been explained, but it is not limited to the C language and it can be applied as long as it is a programming language having a loop statement.

In addition, in the design support apparatus explained already, various data may be inputted and outputted to the storage device 4 through a network such as a local area network (LAN). In this case, it is necessary to further equip the design support apparatus with a communication control device etc. for controlling communication with the network.

Thus, it should be understood that the invention includes various embodiments etc. which are not explained herein. Therefore, the invention is limited by only particular matters of the invention of the appropriate claims from this disclosure.

As described with reference to the embodiment and the modified example thereof, there is provided a design support apparatus for designing a desired pipeline circuit easily in a short time.

What is claimed is:

1. A design support apparatus for designing a logic circuit, the apparatus comprising:
a display device;
a behavioral description storage section that stores behavioral description that describes functions of the logic circuit;
a loop statement detection section that detects a loop statement that describes a repeat operation from the behavioral description;
a loop statement analysis section that generates structure information that describes a structure of the loop statement by analyzing the loop statement detected by the loop statement detection section; and
a display control section that controls the display device to display the structure information,
wherein the display control section controls the display device to display processes in a loop body defined by the loop statement in a time series manner.

2. The design support apparatus according to claim 1, wherein the loop statement analysis section includes a parallel process detection section that detects parallel executable operations among the operations in the loop body, and
wherein the display control section controls the display device to display the parallel executable operations to be arranged along a direction orthogonal to a time axis direction.

3. The design support apparatus according to claim 1, wherein the loop statement analysis section includes a hierarchical structure detection section that detects a hierarchical structure indicating that another loop statement is included in the loop body defined by the loop statement detected by the loop statement detection section, and
wherein the display control section controls the display device to display operations of each of the loop bodies of the loop statement included in the loop statement detected by the loop statement detection section and the another loop statement in a time series manner.

4. The design support apparatus according to claim 1, wherein the loop statement analysis section includes a dependency detection section that detects a data dependency indicating that operations in the loop body depends on the execution of the previous iteration, and
wherein the display control section controls the display device to display information about the data dependency on the display device.

5. The design support apparatus according to claim 1, wherein the display control section prompts to a designer to input a high-level synthesis constraint that is constraint on high-level synthesis for generating circuit description from the behavioral description,
wherein the design support apparatus further comprises:
a high-level synthesis constraint setting section that sets the high-level synthesis constraint and generates a high-level synthesis constraint description from the high-level synthesis constraint being set; and
a high-level synthesis section that performs high-level synthesis of the behavioral description using the high-level synthesis constraint description.

6. A method for designing a logic circuit, the method comprising:
storing behavioral description that describes functions of the logic circuit;
detecting a loop statement that describes a repeat operation from the behavioral description;
generating structure information that describes a structure of the loop statement by analyzing the loop statement detected by the loop statement detection section;
displaying the structure information; and
displaying operations in a loop body defined by the loop statement in a time series manner.

7. The method according to claim 6 further comprising:
detecting parallel executable operations among the operations in the loop body; and
displaying the parallel executable operations to be arranged along a direction orthogonal to a time axis direction.

8. The method according to claim 6 further comprising:
detecting a hierarchical structure indicating that another loop statement is included in the loop body defined by the detected loop statement; and
displaying operations of each of the loop bodies of the loop statement included in the detected loop statement and the another loop statement in a time series manner.

9. The method according to claim 6 further comprising:
detecting a data dependency indicating that operations in the loop body depends on the previous execution of operations; and
displaying information about the data dependency on the display device.

10. The method according to claim 6 further comprising:
prompting to a designer to input a high-level synthesis constraint that is constraint on high-level synthesis for generating circuit description from the behavioral description;
generating a high-level synthesis constraint description from the high-level synthesis constraint being input by the designer; and
performing high-level synthesis of the behavioral description using the high-level synthesis constraint description.

11. A design support apparatus for designing a logic circuit, the apparatus comprising:
a display device;
a storage that stores behavioral description that describes functions of the logic circuit; and
a processor that operates to:
detect a loop statement that describes a repeat operations from the behavioral description;
generate structure information that describes a structure of the loop statement by analyzing the loop statement detected by the loop statement detection section;
control the display device to display the structure information; and
control the display device to display operations in a loop body defined by the loop statement in a time series manner.

12. The apparatus according too claim 11, wherein the processor further operates to:
detect parallel executable operations among the operations in the loop body; and
control the display device to display the parallel executable operations to be arranged along a direction orthogonal to a time axis direction.

13. The apparatus according to claim 11, wherein the processor further operates to:
detect a hierarchical structure indicating that another loop statement is included in the loop body defined by the detected loop statement detected; and
control the display device to display operations of each of the loop bodies of the loop statement included in the detected loop statement and the another loop statement in a time series manner.

14. The apparatus according to claim 11, wherein the processor further operates to:
detect a data dependency indicating that process in the loop body depends on the execution of the previous iteration; and
control the display device to display information about the data dependency on the display device.

15. The apparatus according to claim 11 further comprising an input device to allow a designer to input operations,
wherein the processor further operates to:
prompt to the designer to input through the input device a high-level synthesis constraint that is constraint on high-level synthesis for generating circuit description from the behavioral description;
generate a high-level synthesis constraint description from the high-level synthesis constraint being input by the designer; and
perform high-level synthesis of the behavioral description using the high-level synthesis constraint description.
